(19) United States
(12) Patent Application Publication
(10) Pub. No.: US 2023/0115946 A1
(43) Pub. Date: Apr. 13, 2023

(54) Fluidized Coated Carbon Particles and Methods of Making

(71) Applicant: Forge Nano Inc., Thornton, CO (US)

(72) Inventors: Chris Gump, Thornton, CO (US); Arrelaine Dameron, Thornton, CO (US); Brianna Boeyink, Thornton, CO (US); Sara Harris, Thornton, CO (US)

(21) Appl. No.: 17/963,183

(22) Filed: Oct. 10, 2022

Related U.S. Application Data
(60) Provisional application No. 63/254,000, filed on Oct. 8, 2021.

(51) Int. Cl. H01M 4/88; H01M 4/92

(52) U.S. Cl. CPC H01M 4/8892; H01M 4/881; H01M 4/8867; H01M 4/926

(57) ABSTRACT

Coatings on carbon are of interest to the battery, fuel cell, and catalyst industries. However, carbon is difficult to process because of its cohesiveness and low density. This invention describes a method for decreasing the interparticle forces between carbon particles so that the powder does not agglomerate as much during processing. This prevents the formation of hard agglomerates during gas phase processes such as Atomic Layer Deposition (ALD) coating. The same method for decreasing agglomeration of the powder during processing may also improve the dispersion of deposited platinum onto carbon particles, either by ALD or other methods. A suspension of carbon particles coated with ionomer is also described.

### RELATED APPLICATIONS

This application claims the priority benefit of U.S. Provisional Patent Application Ser. No. 63/254,000 filed Oct. 9, 2021.

### INTRODUCTION

Proton exchange membrane fuel cells (PEMFCs) are multi-layer structures comprising catalyst layers separated by a proton exchange membrane (PEM). A typical catalyst layer comprises platinum particles supported on the surface of carbon particles with interstitial spaces filled with an ionomer such as Nation®. These structures are described in publications such as Thampan et al., “PEM fuel cell as a membrane reactor,” Catalysis Today 67 (2001) pp 15-32. Over many years, intensive efforts have been focused on making improved catalyst layers for PEM fuel cells. For example, see Costamagna et al., “Quantum jumps in the PEMFC science and technology from the 1960s to the year 2000” J. power Sources 102, 242-252 (2001). Conventionally, catalyst layers are made by pretreating carbon particles, such as Vulcan XC-72, with ammonia followed by treatment with chloroplatinic acid to form the Pt-coated carbon particles followed by impregnation with an ionomer. See Chen et al., “Research progress of catalyst layer and interlayer interface structures in membrane electrode assembly (MEA) for proton exchange membrane fuel cell (PEMFC) system, eTransportation 5 (2020) 100075. Despite the importance of PEMFCs, and a long and intensive period of research toward improved materials, there remains a need for better catalyst materials and manufacturing methods for catalyst materials for PEM fuel cells.

### SUMMARY OF THE INVENTION

In a first aspect, the invention provides a suspension of solid carbon particles in a gas wherein the carbon particles are coated with an ionomer layer.

The invention can be further characterized by one or more of the following: wherein the suspension is a fluidized bed comprising an inert gas flowing through a distributor plate and through the carbon particles in a direction counter to a gravitational or centrifugal force; wherein the fluidized bed has a flow rate of at least 20 sccm; wherein the inert gas comprises N₂ or Ar, or a reactive gas, or a combination of inert and reactive gases; wherein the carbon particles are selected from: carbon black, graphite, natural graphite, amorphous graphite, synthetic graphite, pyrolytic graphite, and soot; wherein the carbon particles have a particle diameter (size) such that at least 70 mass % or at least 90 mass % of the carbon particles have a size in the range of 50 nm to 500 nm, or a size in the range of 70 to 400 nm; wherein the carbon particles have a surface area such that at least 70 mass % or at least 90 mass % of the carbon particles have a BET surface area in the range of 500 to 1500 m²/g; or 700 to 1300 m²/g; wherein the ionomer comprises a pendant group comprising a carboxylate or a sulfonate; wherein the ionomer comprises a sulfonated tetrafluoroethylene based fluoropolymer-copolymer; wherein the particles have surfaces and wherein the ionomer layer completely covers the surfaces of the particles; wherein the ionomer further comprising an additional layer so that the ionomer layer is interposed between the carbon particle and the additional layer wherein the additional layer comprises islands of a transition metal; wherein the addition layer comprises Pt or Pd; wherein the ionomer is present in the range of 0.2 to 3 or 0.3 to 2.0 mass %; wherein the ionomer layer has a maximum thickness of at least 0.5 nm or at least 1 nm and at most 20 nm or at most 100 nm or at most 1 μm.

In another aspect, the invention provides a method of processing carbon particles, comprising: coating carbon particles with an ionomer; and fluidizing the ionomer-coated carbon particles. The invention can be further characterized by one or more of the following: forming a solution of carbon particles in a liquid solution; adding an ionomer to form a slurry; mixing the slurry; drying the slurry to remove the liquid solution; and, optionally, deagglomerizing the dried slurry; wherein the fluidized ionomer-coated carbon particles are reacted with an organometallic compound in the gas phase; wherein the ionomer coated particles are further coated by atomic layer deposition (ALD) or Molecular Layer Deposition (MLD; wherein the ionomer coated particles are coated with Pt by atomic layer deposition (ALD).

The invention also includes catalyst layers made by the inventive method.

### DETAILED DESCRIPTION OF THE INVENTION

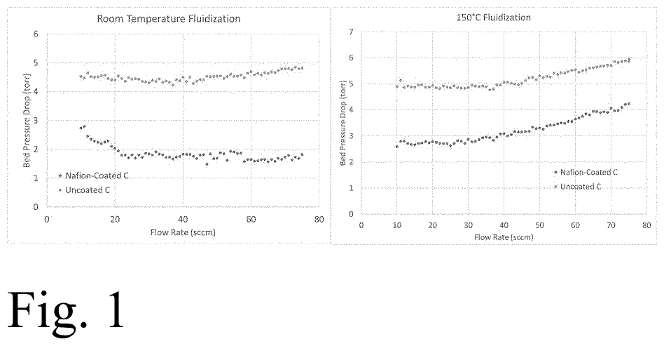

FIG. 1 shows fluidization curves for the uncoated and coated carbon powders.

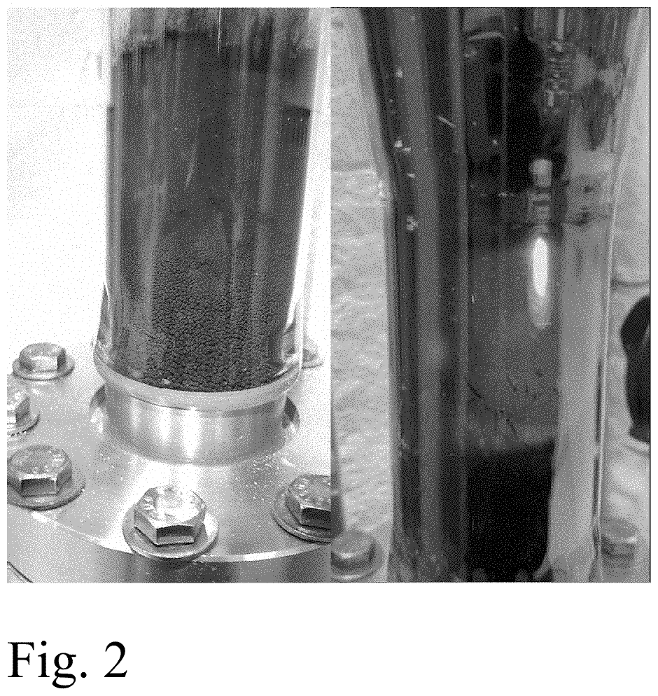

FIG. 2 shows images of the fluidizing carbon. (Left) Uncoated carbon shows minimal bed recirculation and significant agglomeration. (Right) Coated carbon shows more bed expansion, powder recirculation, and no agglomeration.

### DETAILED DESCRIPTION OF THE INVENTION

The invention provides a suspension of solid carbon particles in a gas wherein the carbon particles are coated with an ionomer layer. Preferably, the suspension is a fluidized bed. The fluidized bed preferably comprises an inert gas flowing through a distributor plate and through the carbon particles in a direction counter to the force of gravity. The fluidized bed can have a flow rate of at least 20 sccm or a rate in the range of 20 or 30 to 2000 or 1000 or 200 or 100 sccm. The gas may be an inert gas such as N₂ or Ar, or a reactive gas, or a combination of inert and reactive gases.

The carbon particles, prior to coating, can be any type of carbon, and can be selected from (but not limited to): carbon black, graphite, natural graphite, amorphous graphite, synthetic graphite, pyrolytic graphite, soot, diamond, graphene, glassy carbon, carbon nanotubes, and fullerenes. Carbon particles preferably have a particle diameter (size) such that at least 70 mass % or at least 90 mass % of the carbon particles have a size in the range of 50 nm to 500 nm, or a size in the range of 70 to 400 nm. As is conventional for this size range, particle size refers to the size of individual particles, not the size of a cluster (in the case of agglomerated particles). Carbon particles preferably have a surface area such that at least 70 mass % or at least 90 mass % of the carbon particles have a BET surface area in the range of 500 to 1500 m²/g; or 700 to 1300 m²/g.

An ionomer is a polymer comprising repeat units wherein ionized moieties are covalently bonded to the carbon backbone of the polymer as pendant group moieties. In some preferred embodiments, the pendant group comprises a carboxylate or a sulfonate. As conventionally accepted for the term ionomers, in cases where the counterion is hydrogen (i.e., a carboxylic acid) the hydrogen is considered a proton (H⁺) paired with the carboxylate so that for ionomers the ionized moieties may be considered ionizable. In a particularly preferred embodiment, the ionomer is a sulfonated tetrafluoroethylene based fluoropolymer-copolymer (also known as Nafion®). The ionomers used in fuel cell and catalyst applications typically have sulfonate groups as a part of their structures. Such groups are known to interact with platinum, and may improve the nucleation and dispersion of the platinum onto the carbon support.

The carbon particles coated with an ionomer layer can be coated with an additional layer so that the ionomer layer is interposed between the carbon particle and the additional layer. The additional layer can be a continuous or discontinuous layer. In preferred embodiments, the additional layer comprises islands of a transition metal or catalyst; the transition metal may comprise a catalytic metal such as Pt or Pd. In some embodiments, the additional layer is a continuous layer of a material that is selectively permeable.

The ionomer layer can be continuous or discontinuous; in some embodiments, the ionomer can be present in an amount of 0.2 mass % or more, or 0.5 mass % or more, or 0.8 mass % or more, or in the range of 0.2 to 3 or 0.3 to 2.0 mass % of the particles (or, alternatively, as mass % of the sum of the C core and ionomer coating (ignoring other layers such as layers subsequently applied that overlay the ionomer layer)). In some embodiments, the maximum thickness of the ionomer layer is at least 0.5 nm or at least 1 nm and/or a at most 20 nm or at more 100 nm or at most 1 μm.

The inventive method of processing carbon particles, comprises coating C particles with an ionomer; and fluidizing the ionomer-coated C particles. The coating step may comprise forming a solution of C particles (preferably comprising an alcoholic solution) in a liquid solution; adding an ionomer to form a slurry; mixing the slurry; drying the slurry to remove the liquid solution; and, optionally, deagglomerizing the dried slurry. The step of mixing the slurry may include sonication. The slurry can alternatively or additionally be mixed in a beaker, rotary drum, or ball mill. The drying can be done in an oven, a rotary drier, or a furnace, or air dried or dried in a fluidizer. The deagglomeration can be done with a mortar and pestle, a shaker, ball mill, or a jet mill.

The fluidized ionomer-coated C particles could be treated with a reactive material. For example, the ionomer-coated C particles can be reacted in a chemical vapor deposition reaction, for example with an organometallic compound in the gas phase. Preferably, the ionomer-coated C particles can be reacted with a gas phase reactant. Alternatively, the ionomer-coated C particles can be reacted with an aerosol.

Preferably, the ionomer coated particles are further coated by atomic layer deposition (ALD) or Molecular Layer Deposition (MLD); and the invention also includes the coated particles and fluidized beds comprising the particles. For example, the ionomer coated particles could be coated with a dispersion of Pt or Pd (or other transition metal) particles; the resulting ionomer coated particles with Pt particles (or other transition metal) can optionally be further coated by atomic layer deposition (ALD) or Molecular Layer Deposition (MLD). Alternatively, the ionomer coated particles can be coated in a gaseous suspension by atomic layer deposition (ALD) or Molecular Layer Deposition (MLD) without any other coating treatment.

The method includes the formation of material and the resulting device; for example, a incorporated into a catalyst layer in a fuel cell.

### General Description of Atomic or Molecular Layer Deposition

Atomic layer-controlled growth techniques permit the deposition of coatings of about 0.1 to about 5 angstroms in thickness per reaction cycle, and thus provide a means of extremely fine control over surface coverage or coating thickness. Thicker coatings can be prepared by repeating the reaction sequence to sequentially deposit additional layers of the coating material until the desired coating thickness is achieved.

The coating is deposited in an Atomic Layer Deposition (ALD) or Molecular Layer Deposition (MLD) process. In the ALD/MLD process, the coating-forming reaction is conducted as a series of (typically) two half-reactions. In each of these half-reactions, a single reagent (precursor) is introduced into contact with the substrate surface. Conditions are such that the reagent is in the form of a gas. In most cases, the reagent reacts with functional groups on the surface of the particle and becomes bound to the particle. Because the reagent is a gas, it permeates into pores in the substrate and deposits onto the interior surfaces of the pores as well as onto the exterior surfaces of the substrate. This precursor is designed to react with the surface at all of the available surface sites but not react with itself. In this way, the first reaction occurs to form a single monolayer, or sub-monolayer, and creates a new surface functionality. Excess amounts of the reagent are then removed, which helps to prevent the growth of undesired, larger inclusions of the coating material. Each remaining half-reaction is then conducted in turn, each time introducing a first reagent, allowing it to react at the surface of the particle, and removing excess reagent before introducing the next reagent. Usually, an inert carrier gas is used to introduce the reagents, and the reaction chamber is usually swept with the carrier gas between successive reagent introductions to help remove excess reagents and gaseous reaction products. A vacuum may be pulled during and between successive dosings of reagents, to further remove excess reagents and gaseous reaction products.

After exposure to the first precursor, the surface is then exposed to the second precursor, also typically dispersed in an inert carrier gas. This precursor is designed to react with the functional groups put down in the first reaction step. This reaction also happens until all of the available surface sites are reacted. The second precursor also does not react with itself. Any excess of the second precursor is also removed in an optional inert gas purge step. If the gases are metered properly, the purge step may be unnecessary. This may be at least a 4 step process (precursor 1, purge, precursor 2, purge) to deposit one monolayer of the film which is being grown. This is not meant to imply only a single precursor because some ALD and MLD processes use multiple reactants in a step, for example APTES/H₂O/O₃ for depositing SiO₂. This process is repeated as many times as is necessary to build up the desired film thickness. The ALD/MLD process may start with a “linker” agent, or pre-treatment gas (such as ozone), that facilitates covalent bonding to the surface, or it may end with a terminating agent that may be hydrophobic, hydrophilic, or otherwise engineered for a specific purpose.

For purposes of the present invention, the ALD/MLD process may include only a half reaction, rather than a full cycle. However, at least one full cycle is preferred, more preferably at least five cycles.

A convenient method for applying the coating to a particulate substrate is to form a fluidized or otherwise agitated bed of the particles, and then pass the various reagents in turn through the fluidized bed under reaction conditions. Methods of fluidizing particulate materials are well known, and generally include supporting the particles on a porous plate or screen. A fluidizing gas is passed upwardly through the plate or screen, lifting the particles somewhat and expanding the volume of the bed. With appropriate expansion, the particles behave much as a fluid. Reagents (in gaseous, liquid, or solid phase) can be introduced into the bed for reaction with the surface of the particles. Liquid or solid reagents convert to gaseous form once inside the bed prior to reaction with particles. In this invention, the fluidizing gas also can act as an inert purge gas for removing unreacted reagents and volatile or gaseous reaction products. In addition, the reactions can be conducted at particle surfaces in a rotating cylindrical vessel, a rotating tube, or a vibrating bed. This vibrating bed method is particularly suitable for continuous processes.

Reaction conditions are selected mainly to meet three criteria. The first criterion is that the reagents are gaseous under the conditions of the reaction. Therefore, temperature and pressure conditions are selected such that the reactants volatilize before reaction. The second criterion is one of reactivity. Conditions, particularly temperature, are selected such that the desired reaction between the film-forming reagents (or, at the start of the reaction, the first-introduced reagent and the particle surface) occurs at a commercially reasonable rate. The third criterion is that the substrate is thermally stable, from a chemical standpoint and from a physical standpoint. The substrate should not degrade or react at the process temperature, other than a possible reaction on surface functional groups with one of the ALD precursors at the early stages of the process. Similarly, the substrate should not melt or soften at the process temperature, so that the physical geometry, especially pore structure, of the substrate is maintained. The reactions are generally performed at temperatures from about 270 to 1000 K, preferably from 290 to 450 K, with specific temperatures in each case being below the temperature at which the substrate melts, softens or degrades.

Between successive dosings of the reagents, the particles are subjected to conditions sufficient to remove reaction products and unreacted reagents. This can be done, for example, by subjecting the particles to a high vacuum, such as about 10⁻⁵ Torr or greater, after each reaction step. Another method of accomplishing this, which is more readily applicable for industrial application, is to sweep the particles with an inert purge gas between the reaction steps. This purge gas can also act as a fluidizing medium for the particles and as a carrier for the reagents.

Several techniques are useful for monitoring the progress of the reaction. For example, vibrational spectroscopic studies can be performed using transmission Fourier transform infrared techniques. The deposited coatings can be examined using in situ spectroscopic ellipsometry. Atomic force microscopy studies can be used to characterize the roughness of the coating relative to that of the surface of the substrate. X-ray photoelectron spectroscopy and x-ray diffraction can be used to do depth-profiling and ascertain the crystallographic structure of the coating.

Aluminum oxide coatings are conveniently deposited using trimethylaluminum and water as the precursors, as illustrated by reaction sequence A1/B1. The illustrated reactions are not balanced, and are only intended to show the reactions at the surface of the substrate (i.e., not inter- or intralayer reactions).

Substrate-XH*+Al(CH₃)₃=Substrate-X—Al*—CH₃+CH₄ (precursor reaction)

Substrate-X—Al*—CH₃+H₂O=Substrate-X—Al—OH*+CH₄ (A1)

Substrate-X—Al—OH*+Al(CH₃)₃=Substrate-X—Al—O—Al*—CH₃+CH₄ (B1)

In reactions A1/B1, X is typically oxygen, nitrogen or sulfur, and the asterisk (*) represents the surface species at which the next half-reaction can occur. An aluminum oxide film is built up by repeating reactions A1 and B1 in alternating fashion, until the desired coating thickness is achieved. Aluminum oxide films tend to grow at a rate of approximately 0.1 nm/cycle using this reaction sequence.

Titanium oxide coatings are conveniently deposited using titanium tetrachloride and water and/or hydrogen peroxide as the precursors, as illustrated by reaction sequence A2/B2. As before, the illustrated reactions are not balanced, and are only intended to show the reactions at the surface of the particles (i.e., not inter- or intralayer reactions).

Substrate-XH*+TiCl₄=Substrate-X—Ti*—Cl₃+HCl (precursor reaction)

Substrate-X—Ti*—Cl₃+H₂O₂=Substrate-X—Ti*—OH+HCl+Cl₂ (A2)

Substrate-X—Ti*—OH+TiCl₄

Substrate-X—Ti—O—Ti*—Cl₃+—HCl (B2)

In reactions A2/B2, X is typically oxygen, nitrogen or sulfur, and the asterisk (*) represents the surface species at which the next half-reaction can occur. A titanium oxide film is built up by repeating reactions A2 and B2 in alternating fashion, until the desired coating thickness is achieved. Titanium oxide films tend to grow at a rate of approximately 0.05-0.1 nm/cycle using this reaction sequence.

As is known for ALD/MLD processes, the order can be AB, ABC, ABCD, ABCDABABCD, or any desired order provided that the chemical entities react with each other in the desired order. Each of the reactants has at least two reactive moieties (this includes the possibility that the reactant is modifiable to have two reactive moieties such as having a first reactive moiety and a second reactive moiety that is temporarily blocked by a protecting group or requires activation for subsequent reaction such as UV activation). In some preferred embodiments, the reactants have exactly two reactive moieties since higher numbers of reactive groups may lead to lower packing density. In some preferred embodiments, the films have at least three repeating units (e.g., ABABAB), or at least 5, or at least 10, or at least 50, and sometimes in the range of 2 to 1000, or 5 to 100. By “reactive” it is meant under normal MLD conditions and commercially relevant timescales (for example, at least 50% reacted within 10 hours under appropriate reaction conditions). For control of film quality, the reactants may be singly reactive during each step of the MLD process to avoid reacting twice to the surface, and the reactants should not self-react and condense onto the surface.

In some preferred embodiments, the reactive moieties for Reactant A may comprise: isocyanates (R—NCO), acrylates, carboxylic acids, esters, epoxides, amides and amines, and combinations thereof. In some preferred embodiments, Reactant A comprises a diisocyanate, a diacrylate, a dicarboxylic acid, a diester, diamide or a diamine. In some preferred embodiments, the reactive moieties on Reactant B comprise: alcohols or amines, and combinations thereof. In some preferred embodiments, Reactant B comprises a diol, an amine alcohol, or a diamine.

In some cases, especially for MLD, the vapor phase reactants [?]selected react only monofunctionally with the substrate or growing polymer chain, i.e., only one group or moiety on the vapor phase reactant is capable of reacting with the substrate or growing polymer chain under the conditions of the reaction. This prevents unwanted cross-linking or chain termination that can occur when a vapor phase reactant can react polyfunctionally. A reactant is considered to react “monofunctionally” if during the reaction the reactant forms a bond to only one polymer chain, and does not self-polymerize under the reaction conditions employed. As explained more fully below, it is possible in certain embodiments of the invention to use a vapor phase reactant that can react difunctionally with the substrate or growing polymer chain, provided that the vapor phase reactant contains at least one additional functional group. Reactants that have exactly two functional groups which have approximately equal reactivity are preferably avoided in this aspect of invention.

A first class of suitable vapor phase reactants are compounds having two different reactive groups, one of which is reactive with a functional group on the substrate or polymer chain and one of which does not readily react with a functional group on the polymer chain but is reactive with a functional group supplied by a different vapor phase reactant. Examples of reactants of this class include:

a) Hydroxyl compounds having vinyl or allylic unsaturation. These can react with a carboxylic acid, carboxylic acid halide, or siloxane group to form an ester or silicone-oxygen bond and introduce vinyl or allylic unsaturation onto the polymer chain. Alternatively, the unsaturated group can react with a primary amino group in a Michaels reaction to extend the polymer chain and introduce a hydroxyl group onto the chain.

b) Aminoalcohol compounds. The amino group can react with a carboxyl group, a carboxylic acid chloride, a vinyl or allylic group, or an isocyanate group, for example, to extend the polymer chain and introduce a hydroxyl group onto the chain. Alternatively, the hydroxyl group can react with a siloxane species to form a silicon-oxygen bond and introduce a free primary or secondary amino group.

A second class of suitable vapor phase reactants includes various cyclic compounds which can engage in ring-opening reactions. The ring-opening reaction produces a new functional group which does not readily react with the cyclic compound. Examples of such cyclic compounds include, for example:

a) Cyclic azasilanes. These can react with a hydroxyl group to form a silicon-oxygen bond and generate a free primary or secondary amino group.

b) Cyclic carbonates, lactones and lactams. The carbonates can react with a primary or secondary amino group to form a urethane linkage and generate a free hydroxyl group. The lactones and lactams can react with a primary or secondary amino group to form an amide linkage and generate a free hydroxyl or amino group, respectively.

A third class of vapor phase reactants includes compounds that contain two different reactive groups, both of which are reactive with a functional group on the polymer chain, but one of which is much more highly reactive with that functional group. This allows the more reactive of the groups to react with the functional group on the polymer chain while leaving the less reactive group unreacted and available for reaction with another vapor phase reactant.

A fourth class of vapor phase reactants includes compounds that contain two reactive groups, one of which is blocked or otherwise masked or protected such that it is not available for reaction until the blocking, masking or protective group is removed. The blocking or protective group can be removed chemically in some cases, and in other cases by thermally decomposing the blocking group to generate the underlying reactive group, by radiating the group with visible or ultraviolet light, or in a photochemical reaction. The unprotected group may be, for example, an amino group, anhydride group, hydroxyl group, carboxylic acid group, carboxylic anhydride group, carboxylic acid ester group, isocyanate group and the like. The protected group may be one which, after removal of the protective group, gives rise to a functional group of any of the types just mentioned.

A reactant of this fourth class may, for example, have a hydroxyl group protected by a leaving group such as a benzyl, nitrobenzyl, tetrahydropyranyl, —CH₂OCH₃ or similar group. In these cases, the hydroxyl group can be deprotected in various ways, for example by treatment with HCl, ethanol, or in some cases, irradiation. Carboxyl groups can be protected with leaving groups such as —CH₂SCH₃, t-butyl, benzyl, dimethylamino and similar groups. These groups can be deprotected by treatment with species such as trifluoroacetic acid, formic acid, methanol or water to generate the carboxylic acid group. Amino groups can be protected with groups such as R—OOC—, which can be removed by reaction with trifluoroacetic acid, hydrazine or ammonia. Isocyanate groups can be protected with carboxyl compounds such as formic acid or acetic acid.

A fifth class of vapor phase reactants contains a first functional group, and a precursor group at which a further reaction can be conducted to produce a second functional group. In such a case, the first functional group reacts to bond to the polymer chain, and chemistry is then performed at the precursor group to generate a second functional group. The first functional group can be any of the types mentioned before, including a siloxane group, amino group, anhydride group, hydroxyl group, carboxylic acid group, carboxylic anhydride group, carboxylic acid ester group, isocyanate group and the like. A wide variety of precursor groups can be present on this type of reactant.

The precursor group may be one that it does not itself react with the polymer chain, but it can be converted to a functional group that can react with another vapor phase reactant to grow the chain. Two notable types of precursor groups are vinyl and/or allylic unsaturation, and halogen substitution, especially chlorine or bromine. Vinyl and allylic unsaturation can be converted to functional groups using a variety of chemistries. These can react with ozone or peroxides to form carboxylic acids or aldehydes. They can also react with ammonia or primary amino to produce an amine or imine. Halogens can be displaced with various functional groups. They can react with ammonia or primary amine to introduce an amino group, which can in turn be reacted with phosgene to produce an isocyanate group, if desired.

Reactants that are used to convert a precursor group to a functional group or to demask or deprotect a functional group, are introduced in the vapor phase. Excess reactants of this type are removed prior to the introduction of the next reactant, typically by drawing a high vacuum in the reaction zone, purging the chamber with a purge gas, or both. Reaction by-products are removed in the same manner, before introducing the next reactant into the reaction zone

In some preferred embodiments at least one or all of the reactants in the MLD repeating units have chain lengths between reactive moieties of from 2 to 20 atoms (typically carbon atoms although heterogroups such as oxygen may be present), or from 2 to 10 atoms, or from 2 to 5 atoms. In some preferred embodiments, the reactants have straight chains (i.e., no branching) between reactive moieties to enhance packing density. In some preferred embodiments, the chains between reactive moieties are non-reactive; however, in some embodiments, there may be moieties within the chains that are capable of cross-linking to adjacent chains. In some embodiments, the capping layer and/or the MLD layers at or very near the surface (e.g., within 5 cycles or within 2 cycles of the capping layer or surface) are branched for enhanced hydrophobicity.

An inorganic layer applied to the particle in a first step preferably becomes covalently bonded to the substrate. Covalent bonding can occur when the first-to-be-applied precursor compound reacts under the conditions of the atomic layer deposition process with a functional group on the surface of the substrate. Examples of such functional groups are, for example, hydroxyl, carbonyl, carboxylic acid, carboxylic acid anhydride, carboxylic acid halide, primary or secondary amino.

Some ALD coatings are aluminum oxide and/or titanium oxide coatings. “Aluminum oxide” is used herein to designate a coating that is made up substantially entirely of aluminum and oxygen atoms, without reference to the specific stoichiometry. In many cases, it is expected that an aluminum oxide coating will correspond somewhat closely to the empirical structure of alumina, i.e., Al₂O₃, although deviations from this structure are common and may be substantial. “Titanium oxide” is used herein to designate a coating that is made up substantially entirely of titanium and oxygen atoms, without reference to the specific stoichiometry. In most cases, it is expected that a titanium oxide coating will correspond closely to the empirical structure of titania, i.e., TiO₂, although deviations from this structure are common and may be substantial. Similarly, considerations apply to understanding the other formulations described herein; although in some embodiments, the invention can be more specifically defined by the use of terms such as “consisting.”

Except for the case of a half-reaction included in the broader aspects of the present invention, the atomic layer deposition process is characterized in that at least two different reactants are needed to form the coating layer. The reactants are introduced into the reaction zone individually, sequentially and in the gas phase. Excess amounts of reactant are removed from the reaction zone before introducing the next reactant. Reaction by-products are removed as well, between successive introductions of the reagents. This procedure ensures that reactions occur at the surface of the substrate, rather than in the gas phase.

A purge gas is typically introduced between the alternating feeds of the reactants, in order to further help to remove excess reactants. A carrier gas, which is usually but not necessarily the same as the purge gas, generally (but not always necessarily) is introduced during the time each reactant is introduced. The carrier gas may perform several functions, including (1) facilitating the removal of excess reactant and reaction by-products and (2) distributing the reactant through the reaction zone, thereby helping to expose all surfaces to the reactant. The purge gas does not react undesirably with the ALD reactants or the deposited coating, or interfere with their reaction with each other at the surface of the substrate.

Temperature and pressure conditions will depend on the particular reaction system, as it remains necessary to provide gaseous reactants. As is known for ALD/MLD processes, the temperature should be high enough to enable reactants in the gas phase but not so high that the product degrades.

The coating may comprise any coating that can be applied by molecular or atomic layer deposition. Some well-known coatings that can be applied to the metallic or other material core particle may comprise: oxides or mixed oxides (e.g., Al₂O₃, TiO₂, ZnO, ZrO₂, SiO₂, HfO₂, Ta₂O₅, LiNbₓO_{y}), nitrides (e.g., TiN, TaN, W₂N, TiY₂N), sulfides (e.g., ZnS, CdS, SnS, WS₂, MoS₂, ZnIn₂S₄), and phosphides (e.g., GaP, InP, Fe_{0.5}Co_{0.5}P). Some lesser known materials that can be applied to the core particle may comprise: transition metals (e.g., of Al, Cu, Co, W, Cr, Fe, Zn, Zr, Pt, Pd), metal fluorides (e.g., AlF₃, MgF₂, ZnF₂), oxy fluorides and oxy nitrides of transition metals, lanthanides in either elemental, oxide, fluoride, nitride, boride, or sulfide form (e.g., Y, YN, La₂O₃, LaF₃, Nb, Dy₂O₃, Nd, LaB₆, La₂S₃ etc), borides (e.g., TiB₂), carbides (e.g., B₄C, WC), silanes, silicides and other silicon containing materials, carbon-containing materials including, but limited to, polymers (e.g., polyamides, polyethylenes, polyamides, polyureas, polyurethanes), hydrocarbons, polymers or fragments of amino acids or other biological-related molecules and polymers, and other materials), fluorinated polymers (e.g., fluoro or perfluoro-polyamides, -polyethylenes, -polyamides, -polyureas, -urethanes, -hydrocarbons). This coating is highly uniform over the particle; preferably, there is no more than a 20%, more preferably no more than 10%, or no more than 5% variation in coating thickness over the surface of the particle. This high level of uniformity is a characteristic of the ALD/MLD process. Particles coated by ALD/MLD are distinguishable from particles coated by other methods by 1) the uniformity of film thickness and 2) the lack of change in particle size distribution of the individual core particles, which are not possible with other techniques.

Coatings, on core powders, typically have a thickness in the range of 0.1 to 100 nm; preferably 0.2 to 50 nm; more preferably 0.5 to 10 nm, or 0.2 nm to 2 nm. Coating thickness can be measured by transmission electron microscopy (TEM). An ALD/MLD coating may cover 20% of the surface or less, or at least 20% of the surface, or at least 60% of the surface, or at least 80%, or at least 95% and still more or at least 99% of the surface area of the particles.

ALD forms unique structures that can be distinguished from materials deposited from other techniques. For example, platinum (Pt) deposited by ALD forms unique structures on strontium titanate. Wang et al., “Controllable ALD synthesis of platinum nanoparticles by tuning different synthesis parameters,” J. Phys. Appl. Phys. 50 (2017) 415301. In the present invention, Pt can be deposited by known methods such as by ALD of Pt from trimethylmethylcyclopentadienylplatinum (MeCpPtMe3) and water.

### EXAMPLES

We have found that depositing an ionomer overcoat onto carbon particles improves the fluidization characteristics of the particles. Without the ionomer overcoat, high surface area carbons will often form spherical agglomerates with sizes on the order of millimeters. With the ionomer overcoat, the carbon powder doesn't agglomerate into the large spheres, and during fluidization the bed shows significantly more mixing.

### Example 1

To overcoat the carbon with ionomer:
1. Combine the carbon, the ionomer, and a solvent. The relative ratios can be varied across a wide range, but suitable values include

| Component | Quantity | |
|---|---|---|
| EC-300J Carbon | 10 | g |
| Nafion 117 solution | 1 | g |
| 5 wt % Nafion | | |
| 15-20 wt % H₂O | | |
| Balance aliphatic alcohols | | |
| Ethanol | 40 | ml |

2. Mix the slurry to fully disperse the carbon.
3. Dry the slurry. Because of its ionic nature, the Nafion has no vapor pressure and will not evaporate. Only it and the carbon will remain behind.
4. Deagglomerate the dried cake. If desired, the powder can be sieved to remove any remaining large agglomerates.
   The overcoated carbon can then be loaded into a fluidized bed reactor and processed under normal ALD conditions.

### Example 2

Nafion-coated carbon black was prepared by combining:
20 g EC-300J carbon
2 g 5 wt % Nafion in alcohol solution
200 ml Ethanol
   Sonicate the mixture for 90 minutes. Evaporate the ethanol at 100° C. for 3 hours. Break up agglomerates and sieve to 300 microns or less.

Batches of uncoated and Nafion-coated carbon were loaded into a glass 75 ml fluidized bed reactor. Fluidization behavior was characterized both at room temperature and at 150° C. In each test, the flow of the nitrogen carrier gas was varied, and the pressure drop through the system was measured using a pressure gauge in the dose zone and in the bed zone of the system. The pressure drop through the bed was calculated by subtracting the pressure data through the empty reactor from the pressure data for the filled reactor. Fluidization behavior was also filmed through the glass walls of the reactor.

FIG. 1 shows the fluidization curves for the uncoated and coated carbons at room temperature and 150° C. Note that all curves show little dependence of bed pressure drop on flow rate over the entire range tested. This is the hallmark of fluidization: increasing the flow causes the particles to move further apart, providing more area for gas flow and no increase in pressure drop. We expect that flow rates below the range tested, the pressure should have a linear dependence on flow rate, passing through the origin. The pressure drop through the Nafion-coated carbon beds is lower than the pressure drop through the corresponding uncoated carbon. This is an indication that the Nafion coating reduced the interparticle forces in the carbon, and that less viscous shear was required to separate the particles and fluidize them effectively.

Visual inspection of the bed showed significant differences in the fluidization behavior. FIG. 2 shows the images of the uncoated (left) and coated (right) carbons fluidizing in the glass reactor. Note the large spherical agglomerates at the bottom of the uncoated carbon bed. These agglomerates are not present in the coated carbon. What's more, the coated carbon bed expanded significantly more during fluidization, an indication of better fluidization behavior. This is another indication that interparticle forces between the carbon particles play a stronger role in the fluidization of the uncoated carbon.

1. A suspension of solid carbon particles in a gas wherein the carbon particles are coated with an ionomer layer.

2. The suspension of claim 1 wherein the suspension is a fluidized bed comprising an inert gas flowing through a distributor plate and through the carbon particles in a direction counter to a gravitational or centrifugal force.

3. The suspension of claim 2 wherein the fluidized bed has a flow rate of at least 20 sccm.

4. The suspension of claim 2 wherein the inert gas comprises N₂ or Ar, or a reactive gas, or a combination of inert and reactive gases.

5. The suspension of claim 1 wherein the carbon particles are selected from: carbon black, graphite, natural graphite, amorphous graphite, synthetic graphite, pyrolytic graphite, and soot.

6. The suspension of claim 1 wherein the carbon particles have a particle diameter (size) such that at least 70 mass % or at least 90 mass % of the carbon particles have a size in the range of 50 nm to 500 nm, or a size in the range of 70 to 400 nm.

7. The suspension of claim 1 wherein the carbon particles have a surface area such that at least 70 mass % or at least 90 mass % of the carbon particles have a BET surface area in the range of 500 to 1500 m²/g; or 700 to 1300 m²/g.

8. The suspension of claim 1 wherein the ionomer comprises a pendant group comprising a carboxylate or a sulfonate.

9. The suspension of claim 1 wherein the ionomer comprises a sulfonated tetrafluoroethylene based fluoropolymer-copolymer.

10. The suspension of claim 1 wherein the particles have surfaces and wherein the ionomer layer completely covers the surfaces of the particles.

11. The suspension of claim 1 wherein the ionomer further comprising an additional layer so that the ionomer layer is interposed between the carbon particle and the additional layer.

12. The suspension of claim 1 wherein the additional layer comprises islands of a transition metal.

13. The suspension of claim 12 wherein the addition layer comprises Pt or Pd.

14. The suspension of claim 1 wherein the ionomer is present in the range of 0.2 to 3 or 0.3 to 2.0 mass %.

15. The suspension of claim 1 wherein the ionomer layer has a maximum thickness of at least 0.5 nm or at least 1 nm and at most 20 nm or at most 100 nm or at most 1 μm.

16. A method of processing carbon particles, comprising:
coating carbon particles with an ionomer; and
fluidizing the ionomer-coated carbon particles.

17. The method of claim 16 forming a solution of carbon particles in a liquid solution; adding an ionomer to form a slurry; mixing the slurry; drying the slurry to remove the liquid solution; and, optionally, deagglomerizing the dried slurry.

18. The method of claim 16 wherein the fluidized ionomer-coated carbon particles are reacted with an organometallic compound in the gas phase.

20. The method of claim 16 wherein the ionomer coated particles are further coated by atomic layer deposition (ALD) or Molecular Layer Deposition (MLD).

19. The method of claim 18 wherein the ionomer coated particles are coated with Pt by atomic layer deposition (ALD).
